(19) United States
(12) Patent Application Publication
(10) Pub. No.: US 2005/0137014 A1
(43) Pub. Date: Jun. 23, 2005

(54) Electronic gaming device and method of initiating multiplayer game

(76) Inventor: Asko Vetelainen, Jaali (FI)

Correspondence Address: CRAWFORD MAUNU PLLC, 1270 NORTHLAND DRIVE, SUITE 390, ST. PAUL, MN, 55120, US

(21) Appl. No.: 10/743,372

(22) Filed: Dec. 22, 2003

(51) Int. Cl. A63F 13/00

(52) U.S. Cl. 463/42; 463/39

(57) ABSTRACT

A method of initiating a multiplayer game and an electronic gaming device is provided. The device comprises a communication unit providing communication with at least one other gaming device and a memory to store contact information of at least one user of the at least one other gaming device. The information comprises data about the multiplayer capable games supported by the at least one other device. The device further comprises a controlling unit, wherein the controlling unit is configured to send a gaming request to the at least one other gaming device, the request comprising an invitation to play a game supported by both devices; to receive a response to the gaming request from the other device; and to start the game in a multiplayer mode in the device responsive to the positive response.

### FIELD

The invention relates to an electronic gaming device and to simplifying the initiation of multiplayer games between gaming devices.

### BACKGROUND

Electronic gaming devices have gained a wide spread popularity. Especially the use of small portable gaming devices has increased. Game functions have been added also to mobile terminals. Portable gaming devices offer entertainment and relaxation in various ways.

At first, the games offered by these devices were single player games, because this requires no communication abilities from the device. Lately the popularity of multiplayer games has greatly increased. In multiplayer games, several players play the same game with their own devices. Typically, the actions of all participants of the game can be seen in all devices. Multiplayer games are attractive for players because of more sophisticated game plots and unexpected actions due to human spontaneity.

In addition to the communication abilities of the gaming devices, multiplayer games require some communication between the participating players before a multiplayer can be initiated. The players have to agree on the game to be played and also when to play. In prior art this communication has been carried out by either spoken communication with a player within sight or by email messages, short messages or phone calls. After the players have agreed to play, each player has started the game application in a multiplayer mode and in the established contact by using game multiplayer options. These methods are cumbersome as they require the use of separate communication means before the game can be started.

### BRIEF DESCRIPTIONS OF THE INVENTION

An object of the invention is to provide an improved solution for multiplayer gaming. According to an embodiment of the invention, there is provided an electronic gaming device, comprising: a communication unit providing bi-directional communication with at least one other gaming device; a memory to store contact information of at least one user of the at least one other gaming device, the information including data about the multiplayer capable games supported by the at least one other device; a controlling unit connected to the memory and the communication unit, wherein the controlling unit is configured: to send a gaming request to the at least one other gaming device, the request containing an invitation to play a game supported by both devices; to receive a response to the gaming request from the other device; and to start the game in a multiplayer mode in the device responsive to the positive response.

According to an embodiment of the invention, there is provided an electronic gaming device, comprising: a first memory to store information about games currently supported by the device; a communication unit providing bi-directional communication with other gaming devices; a second memory to store contact information about at least one user of at least one other gaming device, the contact information comprising information about the games supported by the at least one other device, a controlling unit connected to the first and the second memory; a user interface connected to the controlling unit, the interface comprising a display, wherein the controlling unit is configured: to display the contact information on the display; to send a gaming request to the at least one other gaming device, the request comprising an invitation to play a game supported by both devices; to receive a response to the gaming request from the other device; and to start the game in a multiplayer mode in the device responsive to the positive response.

According to another embodiment of the invention, there is provided an electronic gaming device, comprising: a communication unit providing bi-directional communication with at least one other gaming device; an user interface comprising a display; a controlling unit connected to the communication unit and the display, wherein the controlling unit is configured: to detect a reception of a gaming request from another device, the request comprising an invitation to play a game supported by both devices; to display the gaming request on the display; to send a response to the sender of the request; and to start the game in the gaming device when sending a positive request to the sender of the request.

According to another embodiment of the invention, there is provided a method of initiating a multiplayer game, comprising: displaying on the display of an electronic gaming device contact information of at least one user of at least one other gaming device, the contact information comprising information about the multiplayer capable games supported by the at least one other device; sending a gaming request to the at least one other gaming device, the request comprising an invitation to play a game supported by both devices; receiving a response to the gaming request from the other device; and starting the game in a multiplayer mode in the gaming device responsive to the positive response.

According to yet another embodiment of the invention, there is provided a method of initiating a multiplayer game, comprising: displaying on the display of a first electronic gaming device contact information of at least one user of at least one other gaming device, the contact information comprising information about the games supported by the at least one other gaming device; sending a gaming request to the at least one other gaming device; the request comprising an invitation to play a game supported by both devices; receiving the request in the other gaming device; sending a response to the gaming request by the other gaming device; and starting the game in a multiplayer mode in the other gaming device if the response was positive; receiving the response to the gaming request in the first gaming device; and starting the game in a multiplayer mode in the first gaming device responsive to the positive response.

The solution of the invention provides several advantages. The solution solves the difficulties involved in initiating a multiplayer game. The establishment of a multiplayer game is faster and more user-friendly than in the prior art solutions. In an embodiment of the invention the gaming device provides a contact application for the user. A contact application stores information of people in a convenient form, such as contact cards or electronic business cards. In an embodiment the user needs only to open the contact card of the desired gaming partner, select a game from a list in the contact card, and a gaming request is sent to the partner. If the partner responds positively, the game is started automatically in a multiplayer mode in both players' gaming devices. Thus, the initialization of the game is greatly simplified compared to the prior art solutions.

The embodiments of the invention may be applied in gaming devices having means for communicating with other gaming devices. The communication may be carried out in several ways, either by a wired connection or by wireless methods, such as short-range radio transmission, infrared or cellular radio system.

### LIST OF DRAWINGS

In the following, the invention will be described in greater detail with reference to the preferred embodiments and the accompanying drawings, in which

FIG. 1 illustrates an example of a network environment,

FIG. 2 illustrates an example of the structure of an electronic gaming device,

FIGS. 3A to 3C illustrate a contact card application,

FIGS. 4 to 7 are flowcharts illustrating embodiments of the invention.

### DESCRIPTION OF EMBODIMENTS

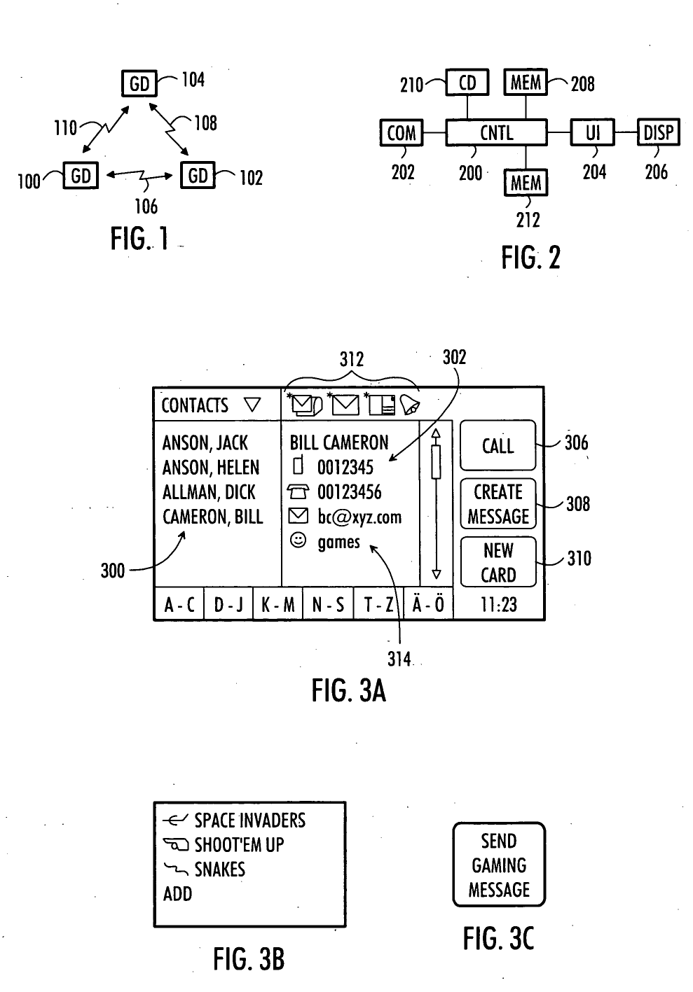

FIG. 1 illustrates an example of a network environment where embodiments of the invention may be applied. In FIG. 1 there are three gaming devices 100, 102, 104. The gaming devices are configured to communicate with each other by using communication connections 106, 108, 110. The connections may be wireless connections which can implemented in many ways. For example, the connections may be realized with short-range radio transmissions such as Bluetooth, or with infrared connections. The connection may also utilize the services of a cellular radio network. In such a case the connection may be a GPRS (General Radio Packet System) connection, for example. The connections may also be realized with a wired network. The distance between the individual devices may exceed the distance usually accepted for voice communication.

In an embodiment, the devices may have several connections open simultaneously. For example, the devices may be GPRS terminals having a phone call open while a GPRS gaming session is on.

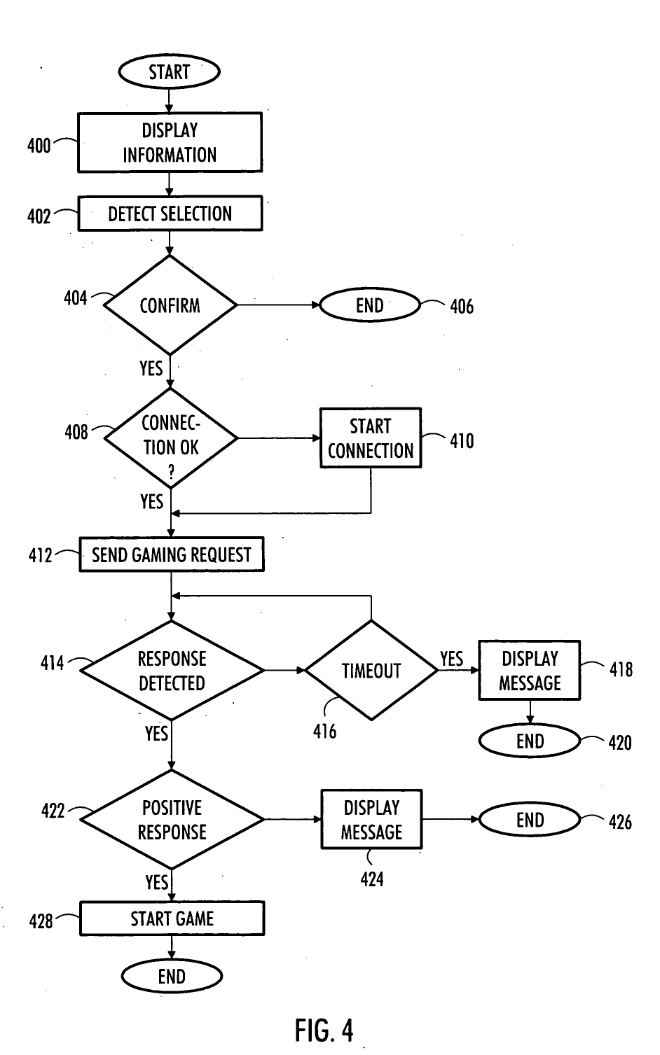

FIG. 2 illustrates an example of the structure of an electronic gaming device. The device comprises a controlling unit 200 controlling the operation of the device. The controlling unit may be realized with a processor provided with suitable software or with separate logic circuits, for example. The device further comprises a communication unit 202 providing a bi-directional communication with other gaming devices. The communication unit 202 may also support other communication purposes. The gaming device may be a mobile terminal in a cellular network, for example. The communication unit 202 may be a GPRS transceiver, a short-range radio transceiver (such as a Bluetooth transceiver, for example) or an infrared transceiver. The communication unit may also support communication via wired connections.

The device further comprises a user interface 204 connected to the controlling unit. The user interface may comprise a display 206. The user interface may also comprise a keyboard or some other input device. User input may also be implemented with a touch sensitive display, for example.

The device further comprises a first memory 208 to store various data required by the operation of the device. The memory may store applications used in the device. The memory may store the games supported by the device.

In an embodiment, the device comprises a removable memory reader 210, such as a card reader. Some games are delivered on readable cards, such as an MMC (Multimedia Card), for example. These cards may be installed into the card reader and the game application can thus be executed on the device.

In an embodiment, game applications may be installed into and removed from the device at the user's will. The games may be downloaded from a network and stored in the memory 208 or they may be executed from a card in the card reader 210. Since various games may be installed into the device, the memory 208 may comprise information about games currently supported by the device. The information may be in the form of a database, for example.

In an embodiment, the device comprises a second memory 212 to store information about contacts. The contact information may comprise names, addresses and other information of people. In an embodiment, the contact information is stored as a database in the memory 212. In an embodiment, the memories 208 and 212 of the device may be implemented with one or more memory units or memory chips.

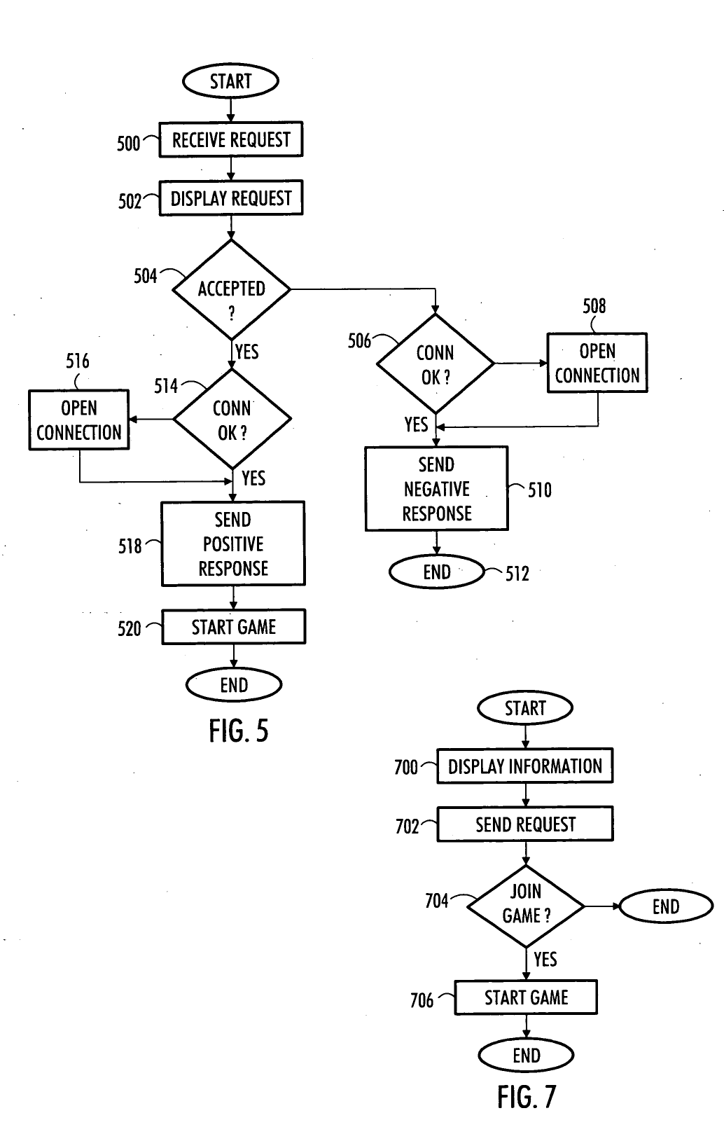

The database may be browsed on the display 206 of the device by using a contact application. The contact application may display the information in a contact card format. A contact card corresponds in a way to an electronic business card. FIG. 3A illustrates an example of a contact card application.

The contact card application comprises a list of contacts 300, which may comprise names or groups comprising several recipients. The application displays the contact information 302 of the selected contact. The contact information typically comprises name, mobile telephone, fixed telephone, mail address and email address, for example. The contact application may comprise various user selectable buttons 306 to 310. By selecting a corresponding button the user may make a call, create a message or create a new contact card, for example. The function of the buttons may vary depending on what is displayed or selected on the card. In addition, the contact application may also comprise various icons 312 for different purposes, such as sound options or creating alerts, for example.

Contact cards may be transmitted between devices using email, short messages or multimedia messages, for example. The cards may be stored in a vCard-format, for example. The vCard format is a common electronic business card format supported by a wide selection of communication devices.

In an embodiment, the contact card comprises information 314 about multiplayer capable games supported by the device of a selected contact. For example, the contact information list 302 comprises a “games” link. When the user selects the link, a list of the multiplayer capable games supported by the device of the selected contact is shown. An example of such a list is illustrated in FIG. 3B. The example shows three multiplayer capable games, which are supported by the device of the contact “Bill Cameron”. In an embodiment, when the user selects a game, one of the buttons of the contact application, for example the “call” button 306, changes to a “Send gaming message” button, as illustrated in FIG. 3C. By pressing this button, the user may initiate a multiplayer session query. In response to the selection, the electronic gaming device sends a gaming request to the selected user's gaming device. The request comprises an invitation to play the selected game supported by both devices. The gaming device may request the user to confirm the sending of the gaming message in the form of a question “Do you want to send a gaming message? OK/Cancel”

In another embodiment, the contact card comprises information 314 about multiplayer capable games supported both by the electronic gaming device and the device of the selected contact. When the user selects this link, a list of the multiplayer capable games supported both by the electronic gaming device and the device of the selected contact is shown.

In yet another embodiment, the games information about the games supported by the electronic gaming device and the device of the selected contact are displayed on the contact card in such a way that the games supported by the device of the selected contact but not by the gaming device itself are dimmed and not selectable.

When a response to the gaming request is received from the other device, the electronic gaming device detects whether the response is a positive response and if it is, the device is configured to start the selected game in a multiplayer mode.

The request may also be sent to a group consisting of several recipients.

The contact application used to browse and control the contact information database is aware of the games currently supported by the gaming device. As games are installed and removed the games database in the memory 208 is updated. The contact application may be configured to monitor the games database.

In an embodiment, the user may update manually the information about the multiplayer games supported by different contacts. For example, when browsing the contact information list 302, the user may select the “games” link and add a game to the list by selecting an “Add” item from a list shown in FIG. 3B. When the user selects the “Add” item, the device can present the user a new list comprising all the games-currently supported by the user's device. The user may then select a supported game and add it to the list of FIG. 3B.

In an embodiment, the user prepares a contact card describing his/her own information and sends the contact card to desired recipients. The contact card comprises information about the games supported by the device of the user.

In an embodiment, the user receives a contact card and stores the card in the contacts application. The contact card comprises information about the games supported by the sender's device.

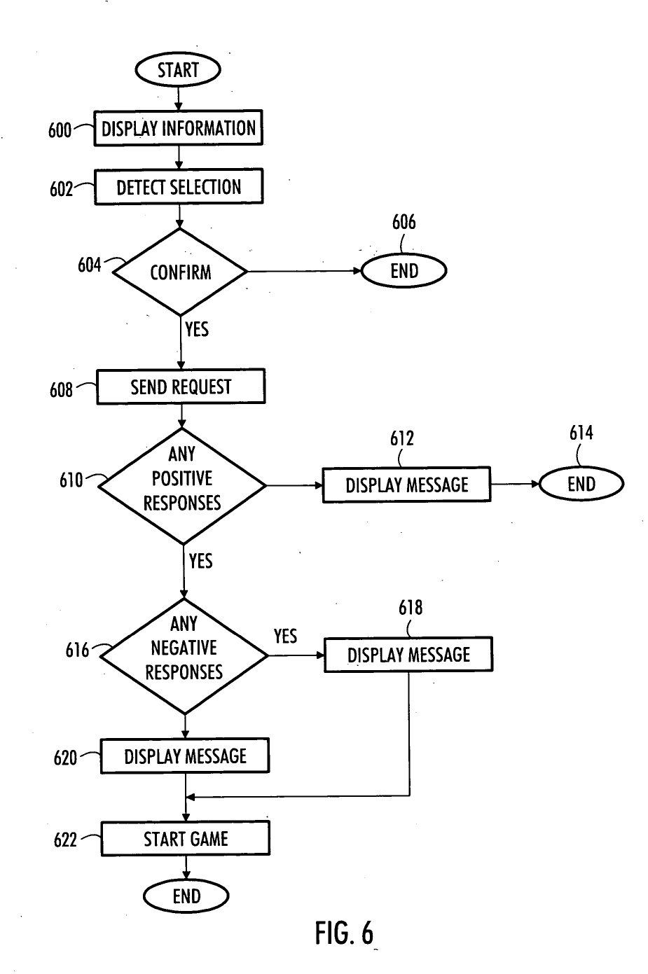

The flow chart of FIG. 4 illustrates an embodiment of the invention. The flow chart describes the actions of the electronic gaming device sending a gaming request. In step 400 the electronic gaming device displays contacts on the display of the gaming device, for example in the form of contact cards. The contact information of the contacts comprises information about the games supported both by the electronic gaming device and at least one other gaming device listed in the contacts.

In step 402 the electronic gaming device detects a selection of a game in the displayed contact information. On the basis of the selection the gaming device initiates the sending of a multiplayer gaming request to the selected user's device.

In step 404 the electronic gaming device asks for a confirmation from the user in the form of a question “Do you want to send a gaming message? OK/Cancel”, for example. The confirmation may also be in some other form.

If the user decides to cancel the request, the process ends in step 406.

In step 408 the electronic gaming device determines whether communication resources are available for sending the request. The request may be sent in various ways, depending on the communication capabilities of the gaming device. If the request is sent as a short-range radio transmission, such as Bluetooth transmission, then no specific connections need to be reserved and the process may proceed directly. The same applies if an infrared connection is utilized in the transmission. In some embodiments, where a wireless or a wired connection is utilized in sending the request, the gaming device determines whether a connection is currently open. If not, the connection is initialized in step 410. Examples of such connections are GPRS-based transmission such as WAP-service (Wireless Application Protocol), or a WLAN (Wireless Local Area Network), for example.

In step 412 the electronic gaming device sends the gaming request to the selected recipient. The gaming request comprises information about the sender of the request. The information may comprise the address of the device in the form of an IP-address (Internet Protocol-address), telephone number, or a corresponding identification on the basis of which a response may be sent. The request may further comprise information about the recipient of the request, such as his/her address in the above formats. The request further comprises information about the requested. The request may further comprise a message to be displayed in the receiving device.

In step 414 the electronic gaming device waits for a response to the request. In an embodiment the device checks 416 periodically whether a predetermined time has lapsed since the request was sent. If the time has been exceeded, a message is displayed to the user in step 418. The message may be of the form “Person X did not respond to your gaming request”, for example. The process ends in step 420.

After having received a response, the electronic gaming device checks in step 422 whether the response was positive. If the response was negative, a message is displayed to the user in step 424. The message may be of the form “Person X rejected your gaming request”, for example. The process ends in step 426.

If the response was positive, the electronic gaming device starts the desired game in a multiplayer mode in step 428. Henceforth the multiplayer game proceeds as in prior art.

The flow chart of FIG. 5 illustrates an embodiment of the invention. The flow chart describes the actions of the electronic gaming device receiving a gaming request. In step 500 the electronic gaming device receives a gaming request. The request may be received via a short-range radio transmission, such as Bluetooth, via an infrared connection, via GPRS-based transmissions or WLAN, or some other wireless or wired connection, for example.

In step 502 the electronic gaming device displays the gaming request on the display of the device. The message may be included in the received message, the receiving device may detect the message type and generate the message. The message may be of the form “Player X would like to play game Y with you. Accept request? Yes/No”, for example.

In step 504 the electronic gaming device detects the user's response to the message. If the response is negative, the electronic gaming device determines in step 506 whether communication resources are available for the sending of the response, and opens the resources in step 508, if needed. The negative response to the gaming request is sent in step 510. The response to the gaming request comprises information about the sender of the response. The information may comprise the address of the device. The response may further comprise information about the recipient of the request. The request further comprises information that the response is negative. The response may further comprise a message to be displayed in the receiving device. The process ends in step 512.

If the response is positive, the electronic gaming device determines in step 514 whether communication resources are available for the sending of the response, and opens the resources in step 516, if needed. The positive response to the gaming request is sent in step 518. The response to the gaming-request comprises information about the sender of the response. The information may comprise the address of the device. The response may further comprise information about the recipient of the request. The request further comprises information that the response is positive. The response may further comprise a message to be displayed in the receiving device.

After sending the positive response the electronic gaming device starts the desired game in a multiplayer mode in step 520. Hereafter the multiplayer game proceeds as in prior art.

The flow chart of FIG. 6 illustrates an embodiment of the invention. The flow chart represents an embodiment where the request is sent to a group consisting of several recipients. The list of recipients in the contact card may comprise contact groups, which in turn comprise several recipients. The contact information in this case comprises a “games” link comprising a list of games supported by all recipients in the group.

The flow chart of FIG. 6 is simplified by omitting the steps relating to the communications and timeouts described in earlier embodiments.

In step 600 the electronic gaming device displays contacts on the display of the gaming device. In step 602 the electronic gaming device detects a selection of a game in the displayed contact information. The device detects that the selection is a contact group. On the basis of the selection, the gaming device initiates the sending of a multiplayer gaming request to the devices of the selected users.

In step 604 the electronic gaming device asks for a confirmation from the user in the form of a question “Do you want to send a gaming message to the selected group? OK/Cancel”, for example. The confirmation may also be in some other form.

If the user decides to cancel the request, the process ends in step 606.

In step 608 the electronic gaming device sends the gaming request to the selected recipients. The gaming request may comprise same information as described in earlier embodiments.

In step 610 the electronic gaming device checks whether any positive responses have been received. If no positive responses have been received, a message is displayed to the user in step 612. The message may be of the form “All persons rejected your gaming request”, for example. The process ends in step 614.

In step 616 the electronic gaming device checks whether any negative responses have been received. If both negative and positive responses have been received, a message is displayed to the user in step 618.

The message may be of the form “Persons X and Y rejected your gaming request, person Z accepted your request”, for example.

If no negative responses have been received, a message is displayed to the user in step 620. The message may be of the form “All persons accepted your request”, for example.

In step 622 the electronic gaming device starts the desired game in a multiplayer mode.

In the above embodiment a timeout limit may be used. When a user receives a gaming request to participate in a multiplayer game with a group of users, a response time limit, within which a positive or a negative response should be received, may be utilized. If a response is not received within the specified time, the response is automatically assumed to be negative.

In several multiplayer games, one of the participating devices acts as a server. The server controls the general game options on behalf of the gamers. In an embodiment the device sending the game request acts as the server for the games set up with the game requests.

FIG. 7 illustrates an embodiment of an ongoing multiplayer game between two users, say user A and user B. The gaming device of user A acts as a server for the game. User C wishes to participate in the game. In step 700 user C displays contact information and selects user A from the contact list. User C selects the game the users A and B are playing and sends a gaming request to user A in step 702. In step 704 user C receives a message from user A. The message may be of the form: “A game is on between players A and B. Want to join in? Yes/No”, for example. The user may join in the game by responding positively, in which case the game is started in the user's device in a multiplayer mode in step 706. Otherwise the procedure ends without starting the game.

In an embodiment, the electronic gaming device is configured to block the reception of gaming requests. Thus the user is not aware of gaming requests sent by others. This may be useful if the user does not want any interruptions. The block may be activated from the communication options of the gaming device, for example. In this case, the sender of a gaming message may receive a message informing the user that the recipient has a gaming request block active.

In an embodiment, the electronic gaming device sets a timer when a reception of a gaming request with a predetermined timeout limit has been detected. If the user of the device has not responded by sending a response within the timeout limit, the second device sends automatically a negative response to the gaming request.

In an embodiment, the electronic gaming device is configured to store information of sent and received gaming requests in an event log in the memory 208 or 212. Thus, the event of the previous example, in which a timeout occurred and a negative response was sent, may also be stored in the event log. The user may afterwards view the log and notice the gaming request and the sent response. From the event log, the user may pick the address of the sender of the original gaming request and send a message or a new gaming request to the original sender, for example.

In an embodiment, a service known as presence information is utilized in the processing of gaming messages. This is an additional service recently created in cellular systems. Presence information refers to a kind of a dynamic profile that the user publishes and that is available to the users that have subscribed to the service. The information may comprise, for instance, data about the availability of the user and about the type of data transmission supported by the user's the terminal. The data concerning all the subscribers utilizing the service is typically maintained in a server of the system, and from there user profiles requested by subscribers can be transferred to the terminal of each subscriber. Thus, the subscriber may for instance search the address book of the terminal for a desired user's profile, which may comprise for instance data about whether the user concerned is available at that particular moment. From this, the subscriber may deduce whether it is worth calling the user in question at that moment. In this embodiment, the electronic gaming device sets a gaming request block according to the current presence information. Thus, if the presence information states that the user is not available, the reception of gaming requests is blocked.

In an embodiment, the gaming request is sent using a messaging application, such as an email application. In the application, the gaming request is handled as a message of a specific format. As the user interface of messaging applications is usually sophisticated, it is easy to send gaming requests to several recipients simultaneously. In addition, free format text is easily inserted into the request.

In an embodiment, the electronic gaming device comprises keys, such as numeric keys. The keys are configured to receive key presses. The electronic gaming device is configured to associate a quick gaming number with at least one key. The quick gaming number comprises the address of a user of another gaming device. When a key is pressed according to a predetermined rule, the gaming device is configured to interpret the key press of the key associated with the quick gaming number as dialing of the quick gaming number. In such a case a menu is displayed to the user, the menu comprising a list of games supported by the gaming device. The user is presented an option to select a game from the list and to send a gaming message to the selected user. Thus, this embodiment enables a quick and easy way to set up a multiplayer game. The predetermined rule may comprise the continuous pressing of a key for a given number of seconds, for example. Thus, if a key is pressed continuously for the given time, the press is interpreted as a quick gaming key press.

In an embodiment, the quick gaming number comprises a contact group. Thus, a multiplayer gaming request may be sent to a plurality of users with a few key presses.

Even though the invention is described above with reference to an example according to the accompanying drawings, it is clear that the invention is not restricted thereto but it can be modified in several ways within the scope of the appended claims.

1. An electronic gaming device, comprising:
a communication unit providing bi-directional communication with at least one other gaming device;
a memory to store contact information of at least one user of the at least one other gaming device, the information including data about the multi-player capable games supported by the at least one other device;
a controlling unit connected to the memory and the communication unit, wherein the controlling unit is configured:
to send a gaming request to the at least one other gaming device, the request containing an invitation to play a game supported by both devices;
to receive a response to the gaming request from the other device; and
to start the game in a multiplayer mode in the device responsive to the positive response.

2. The electronic gaming device of claim 1, further comprising user interface containing a display, wherein the controlling unit is configured to display the contact information on the display.

3. The electronic gaming device of claim 2, wherein the controlling unit is configured to detect a selection of a game in the displayed contact information and to send the gaming request on the basis of the selection.

4. The electronic gaming device of claim 2, wherein the controlling unit is configured
to detect the reception of a gaming request;
to display the gaming request on the display; and
to send a response to the sender of the request.

5. The electronic gaming device of claim 4, wherein the controlling unit is configured to start the game in the gaming device when sending a positive response to the sender of the request.

6. The electronic gaming device of claim 1, wherein the controlling unit is configured to set a timer when sending a gaming request with a predetermined timeout limit and if a response to the request is not received within the timeout limit, the controlling unit is configured to display a message regarding the timeout on the display.

7. The electronic gaming device of claim 1, wherein the device is configured to store information of sent and received gaming requests in an event log.

8. The electronic gaming device of claim 1, wherein the gaming request comprises information about a predetermined timeout limit during which a response is requested.

9. The electronic gaming device of claim 8, wherein the gaming device is configured to set a timer when a reception of a gaming request with a predetermined timeout limit has been detected and, if a response to the request is not sent within the timeout limit, the controlling unit is configured to send a negative response to the gaming request.

10. The electronic gaming device of claim 4, wherein the controlling unit is configured to block the reception of gaming requests.

11. The electronic gaming device of claim 1, wherein the communication unit comprises a terminal of a cellular radio system.

12. The electronic gaming device of claim 1, wherein the communication unit comprises an infrared transceiver.

13. The electronic gaming device of claim 1, wherein the communication unit comprises a short-range radio transceiver.

14. The electronic gaming device of claim 1, wherein the communication unit comprises a transceiver configured to use wired connections.

15. An electronic gaming device, comprising:
a first memory to store information about games currently supported by the device;
a communication unit providing bi-directional communication with other gaming devices;
a second memory to store contact information about at least one user of at least one other gaming device, the contact information comprising information about the games supported by the at least one other device,
a controlling unit connected to the first and the second memory;
a user interface connected to the controlling unit, the interface comprising a display, wherein the controlling unit is configured
to display the contact information on the display;
to send a gaming request to the at least one other gaming device, the request comprising an invitation to play a game supported by both devices;
to receive a response to the gaming request from the other device; and
to start the game in a multiplayer mode in the device responsive to the positive response.

16. An electronic gaming device, comprising a communication unit providing bi-directional communication with at least one other gaming device;
an user interface comprising a display;
a controlling unit connected to the communication unit and the display, wherein the controlling unit is configured
to detect a reception of a gaming request from another device, the request comprising an invitation to play a game supported by both devices;
to display the gaming request on the display;
to send a response to the sender of the request; and
to start the game in the gaming device when sending a positive request to the sender of the request.

17. The electronic gaming device of claim 1, wherein the device comprises keys, the device being configured to associate with at least one key a quick gaming number comprising an address of at least one user of another gaming device.

18. The electronic gaming device of claim 17, wherein the device is configured
to interpret the key press of the key associated with the quick gaming number as dialing of the quick gaming number when the key is pressed according to a predetermined rule; and
to send a gaming request to the at least one other gaming device, the request comprising an invitation to play a game supported by both devices.

19. A method of initiating a multiplayer game, comprising:
displaying on the display of an electronic gaming device contact information of at least one user of at least one other gaming device, the contact information comprising information about the multiplayer capable games supported by the at least one other device;
sending a gaming request to the at least one other gaming device, the request comprising an invitation to play a game supported by both devices;
receiving a response to the gaming request from the other device; and
starting the game in a multiplayer mode in the gaming device responsive to the positive response.

20. The method of claim 19, further comprising:
detecting a selection of a game in the displayed contact information and sending the gaming request on the basis of the selection.

21. The method of claim 19, wherein the gaming request is sent to a multitude of other gaming devices supporting the game.

22. The method of claim 19, further comprising:
sending the gaming request using a messaging-application.

23. A method of initiating a multiplayer game, comprising:
displaying on the display of a first electronic gaming device contact information of at least one user of at least one other gaming device, the contact information comprising information about the games supported by the at least one other gaming device;
sending a gaming request to the at least one other gaming device;
the request comprising an invitation to play a game supported by both devices;
receiving the request in the other gaming device;
sending a response to the gaming request by the other gaming device; and
starting the game in a multiplayer mode in the other gaming device if the response was positive;
receiving the response to the gaming request in the first gaming device; and
starting the game in a multiplayer mode in the first gaming device responsive to the positive response.

24. The method of claim 23, further comprising: ignoring the reception of a gaming request in the gaming device if the reception of gaming requests is blocked.

25. The method of claim 23, further comprising: storing information of sent and received gaming requests in an event log.

26. The method of claim 23, wherein the gaming request comprises information about a predetermined timeout limit during which a response is requested.

27. The method of claim 23, wherein, if a response to the gaming request is not received in the first device during the timeout limit, the game initiation is cancelled.

28. The method of claim 23, wherein the other device sets a timer when a reception of a gaming request with a predetermined timeout limit is detected and, if a response to the request is not sent within the timeout limit, the other device sends a negative response to the gaming request.
